(19) United States
(12) Patent Application Publication
(10) Pub. No.: US 2009/0207701 A1
(43) Pub. Date: Aug. 20, 2009

(54) Date band watch

(76) Inventor: Peter Jacques, Westland, MI (US)

Correspondence Address: JAMES RAY & ASSOCIATES, 2640 PITCAIRN ROAD, MONROEVILLE, PA, 15146, US

(21) Appl. No.: 12/313,939

(22) Filed: Nov. 26, 2008

Related U.S. Application Data
(60) Provisional application No. 61/029,944, filed on Feb. 20, 2008.

(51) Int. Cl. G04B 37/18; G04C 17/00; G04C 3/00

(52) U.S. Cl. 368/205; 368/241; 368/242; 368/282

(57) ABSTRACT

A display for a watchband includes a housing member having a first shell and a second shell member, each shell having a joining means, when assembled such first and second shell members form a cavity. At least a portion of a top surface of such second shell of such housing member is transparent. A predetermined power source is located at a predetermined location within such cavity. A control unit is located at a predetermined location within such cavity operably connected to such power source and having an integrated circuit with a clock function to output day, date and other information. A display mechanism is located within such cavity operably connected to such power source and such control unit. An input mechanism on such housing member is operably connected to such control unit. A band attaching mechanism attaches such housing member to such watch band.

### CROSS REFERENCE TO RELATED APPLICATION

This patent application is related to and claims priority from U.S. Provisional Patent Application Ser. No. 61/029,944 filed Feb. 20, 2008.

### FIELD OF THE INVENTION

The present invention relates, in general, to watch band displays and, more particularly, this invention relates to electro optical watch band displays of day, date and other information.

### BACKGROUND OF THE INVENTION

Prior to the conception and development of the present invention, as is generally well known in the prior art, electronic information display bracelets such as U.S. Pat. No. 6,216,490 issued to Radley-Smith. The Radley-Smith display is controlled by an integrated circuit and uses a liquid crystal display. The displays surround a bracelet and are not an integral part of the bracelet or watchband. Other displays are affixed to a watch such U.S. Pat. No. 6,158,884 issued to Lebby, et al. The Lebby invention does not use the watch band for display, but rather within the watch band conductive fibers electrically couple the electronic unit for form a circuit. The display units are fixed in position relative the watch band.

### SUMMARY OF THE INVENTION

A display for a watchband is provided. Such display includes a housing member having a first shell and a second shell member, each shell having a joining means, when assembled such first and second shell members form a cavity. At least a portion of a top surface of such second shell of such housing member is transparent. A predetermined power source is located at a predetermined location within such cavity. A control unit is located at a predetermined location within such cavity operably connected to such power source and having an integrated circuit with a clock function to output day, date and other information. A display mechanism is located at a predetermined location within such cavity operably connected to such power source and such control unit. An input mechanism on such housing member is operably connected to such control unit. A band attaching mechanism is disposed at a predetermined location on an outer portion of such housing member to attach such housing member to such watch band.

According to another embodiment, an electro-optical display that is an integral part of a watch band or affixed to the band is provided. The display preferably has two housings.

The first housing has an upper portion and a bottom portion. The upper portion of the first housing has a predetermined shape with a lip, an interior surface and exterior surface. The inwardly facing surface is a first cavity. The first cavity has a generally flat bottom. A gear is fixably attached to the approximate center of the bottom of the first cavity. Preferably, the first housing has an upper lip portion having groove with a predetermined width, depth and location. The first cavity has predetermined shape and size. Preferably, the shape is circular.

The second housing has a bottom first shell and a top second shell. At least a portion of the top surface of the second shell is transparent. At least a portion of the first shell and second shell have a joining means that joins the first and second shells together when assembled to form the second housing member. Such joining means may be a tongue and groove type joining means, mating threads or other type of joining means. The interior surface of the second housing is a second cavity. The second housing has a circumferential ridge with a predetermined height width and shape at a predetermined location along the exterior surface of the second housing. The bottom exterior surface of first shell of the second housing has a flexible member, of predetermined length and width. The flexible member is preferably manufactured of one of plastic or metal.

Within the second housing in the preferred embodiment is a predetermined power source, a control unit, electro-optical display. The second housing has at least two selectively engageably switches in the control unit to allow the user to enter the date and day. Preferably, the second housing member has an aperture generally adjacent to the power supply. In the presently preferred embodiment, a panel is removably attached to aperture to permit the user to remove and replace the power supply.

The second housing is received by the first housing and such first and such second retaining means mate to join such first housing and such second housing. A gasket may be disposed between such first and such second mating means to form a watertight seal. The flexible member engages with the gear to permit the user to rotate the second housing unit to discrete positions to be held in position by the gear and the flexible member.

The first housing is attached to the watch band by an attachment means, preferably a tongue and groove linked watchband using a connecting pin. Another embodiment is attaching adjustable straps to the edges of the first housing surrounding and perpendicular to the axis of the solid watchband.

According to still another embodiment a display for a watchband includes a first housing having a predetermined shape and size, such housing having an upper portion with a lip, an inwardly facing surface and outwardly facing surface, the inwardly facing surface is a first cavity, such first cavity having a generally flat bottom surface. A gear is attached to the approximate center of such first housing bottom surface. A first retaining means is disposed on such upper portion of such first housing. A second housing has a first shell and a second shell member, each shell having a predetermined size and shape, such first and second shells having respective mating portions, when assembled such first and second shell members form a second cavity. At least a portion of such second shell of such second housing is transparent. A battery is located in a battery compartment at a predetermined location within such second cavity, such battery being one of nickel-cadmium, lithium ion and alkaline. An aperture disposed through such first housing of such second housing at a predetermined location with a removable panel to provide access to such battery, so that such battery can be replaced. A control unit is located at a predetermined location within such second cavity operably connected to such power source, having an integrated circuit with a clock function to output day, date and other information. A memory unit retains such day, date and other information without a battery. A display means is located at a predetermined location within such second cavity operably connected to such power source and such control unit. At least two switches on such second housing are operably connected to such control unit for entry of such day, date, and other information. A flexible member is attached at a predetermined location to such first shell of such second housing. A second retaining means is disposed on such second housing member, wherein such first and such second retaining means engageably mate. Such second housing is received by such first cavity in such first housing and such first and such second retaining means mate to join such first and such second housings, such flexible member engages such gear so that such second housing rotates and is limited to discrete stops. A band attaching means is disposed on a predetermined location on an outer portion such first housing to attach such first housing to such watch band.

### OBJECTS OF THE INVENTION

It is, therefore, one of the primary objects of the present invention to provide a display unit which provides electro-optical display technology for use by a user in a device which is at least one of attachable to or integrally formed with a watch band and which will not disturb the aesthetics of a face of an analog watch.

Another object of the present invention is to provide a display unit for displaying the day and date and other predetermined information input into such display unit by a user.

Still another object of the present invention is to provide an electro optical display unit for use with a watch band.

Another object of the present invention is to provide an electro-optical display that can be rotated to a preferred position.

Still another object of the present invention is to provide an electro-optical display that is integral to a watch band.

Yet another object of the present invention is to provide an electro-optical display that may be added to an existing watch band.

An additional object of the present invention is to provide an electro-optical display that can be used with an existing link or flexible material watch band.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of one embodiment of the invention in which the display is attached to a watch band.

FIG. 2 is a rear view of the invention as attached to a watch band.

FIG. 3 is a schematic view of the invention according to one embodiment of the invention.

FIG. 4a is a partial perspective view of a watch and corresponding watchband as worn by a user.

FIG. 4b is a partial perspective view of the watch and watchband in FIG. 4a illustrating the display attached to a predetermined portion of such watchband.

FIG. 5 is a perspective view of the display on a watchband according to one embodiment of the invention.

FIG. 6 is a perspective view of the first housing according to one embodiment of the invention.

FIG. 7 is a perspective view of the second housing according to one embodiment of the invention.

FIG. 8 is a cross section of the first housing along line A-A of FIG. 6.

FIG. 9 is a cross section of the second housing along line B-B of FIG. 7.

FIG. 10 is a bottom plan view of the second housing according to one embodiment of the invention.

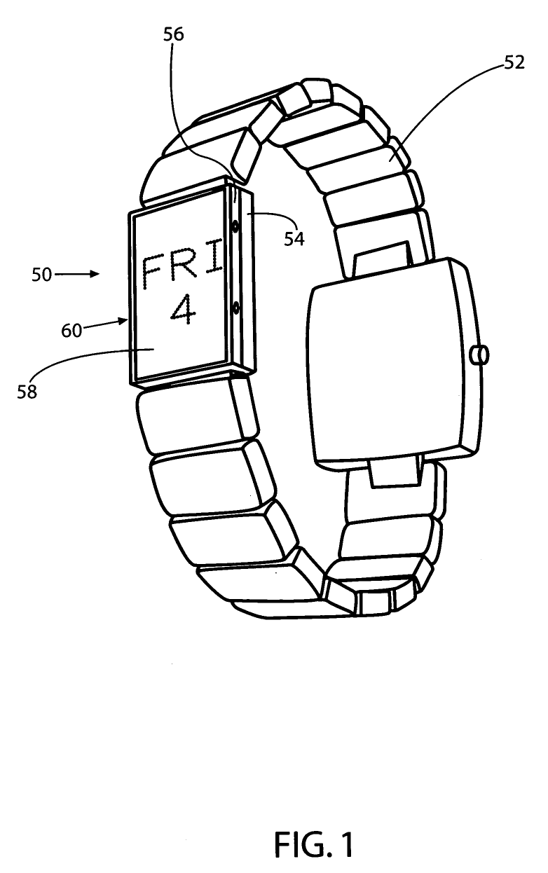

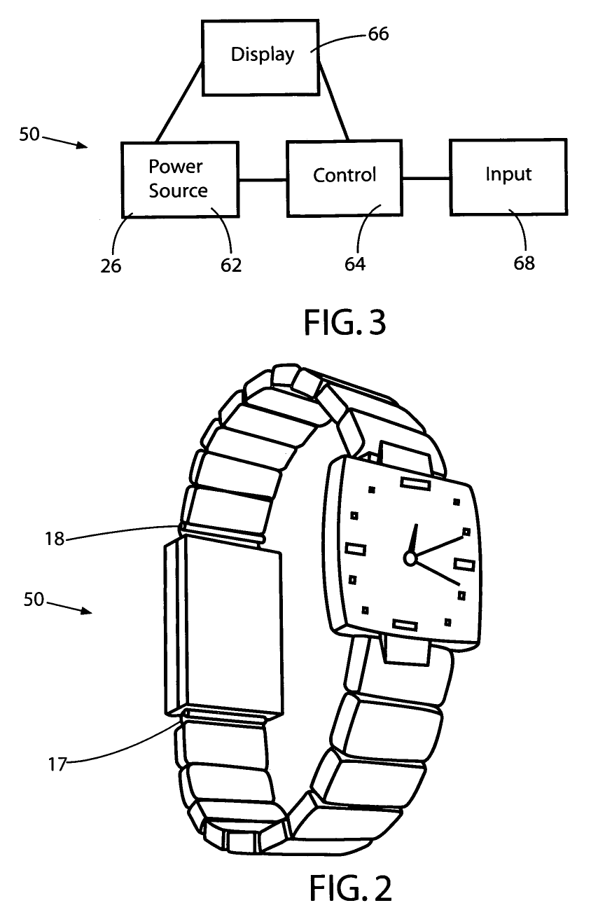

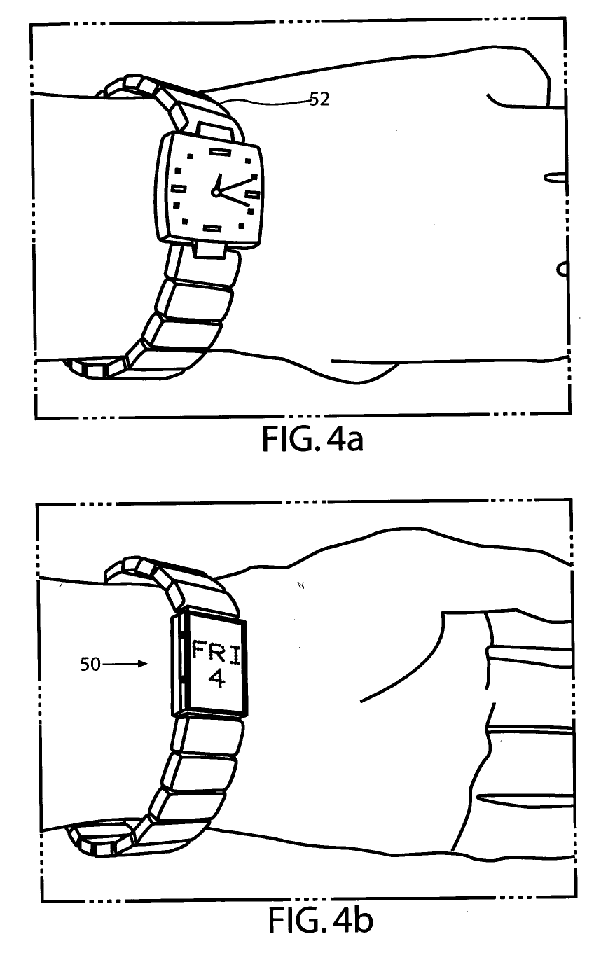

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

A display, generally designated 50, for a watchband 52 is provided. Such display 50 includes a housing member, generally designated 60 having a first shell member 54 and a second shell member 56, each shell having a joining means, when assembled such first and second shell members form a cavity. At least a portion of a top surface 58 of such second shell 56 of such housing member 60 is transparent.

A predetermined power source 62, preferably a battery 26, is located at a predetermined location within such cavity. It is presently preferred that such predetermined power source 62 is one of an alkaline, lithium ion, nickel-cadmium and photo-voltaic.

A control unit 64 is located at a predetermined location within such cavity operably connected to such power source 62 and having an integrated circuit with a clock function to output day, date and other information.

A display means 66 is located at a predetermined location within such cavity operably connected to such power source 62 and such control unit 64. It is presently preferred that such display means 66 is one of an array of light emitting diodes and a liquid crystal display.

An input means 68 on such housing member 60 is operably connected to such control unit 64. It is presently preferred that such housing member 60 has at least 2 apertures and such input means is at least two switches received in an aperture in such housing and wherein such switches are each operably connected to such control unit 64. It is meant that such input means allow a user to input predetermined information such as information relating to calendar months, days, year, time information such as time of day, and other information as desired. For example, medical information as pertaining to a wearer of the device, it being contemplated that such information be retrievable by a predetermined individual in the event of an emergency.

A band attaching means 72 is disposed at a predetermined location on an outer portion of such housing member 60 to attach such housing member 60 to such watch band 52. Such band attaching means may be a conventional hook 18 and pin 17 connector. It is also meant that such device may be integrally formed with at least one of a watchband, a clasp of a watchband, and a combination thereof. However, the device is not meant to be limited as such and such device may be releasably attachable to such watchband via elastic bands or other attaching means.

Additionally, it is presently preferred that such device includes a memory unit (not shown) operably connected to such control unit to retain the date and day for a predetermined interval without a power source.

It is further presently preferred that such housing member includes an aperture disposed there through at a predetermined location generally adjacent to such power source and includes a panel removably attached engaging such housing member to allow a user to replace such power source as necessary.

According to another embodiment, an electro-optical display that is an integral part of a watch band or affixed to the band is provided.

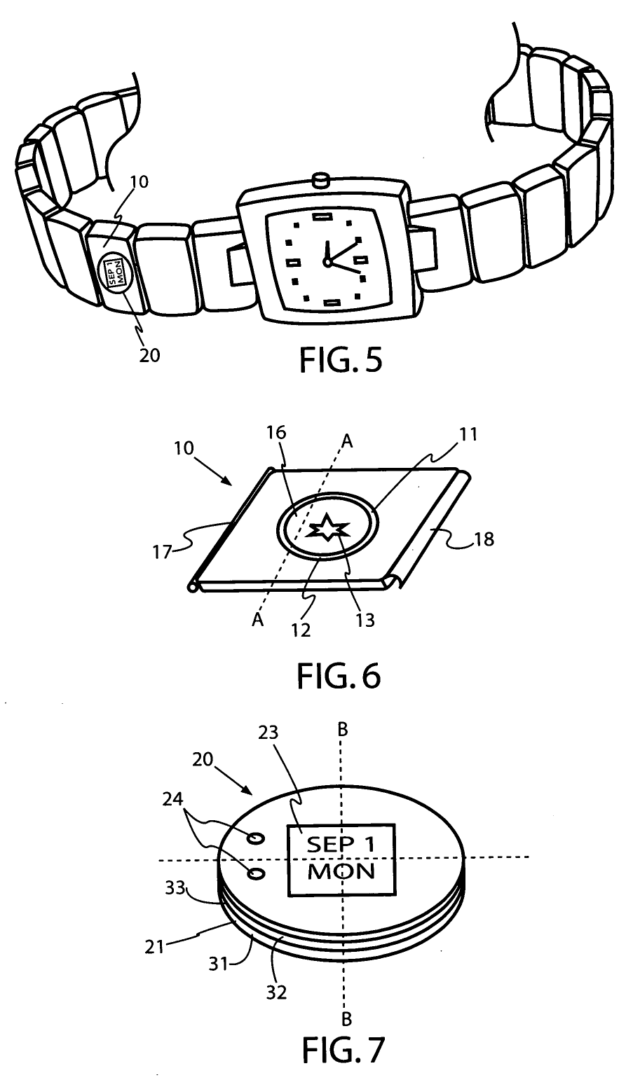

Reference is now made, more particularly, to FIGS. 5-10. FIG. 5 shows the device with a first housing 10 and a second housing 20 attached to a watch band.

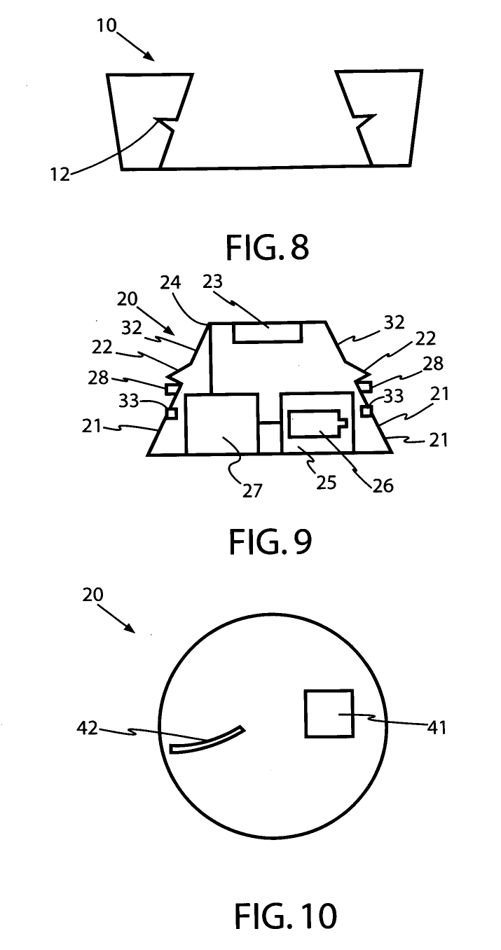

FIGS. 6 and 8 show the first housing 10 with a first cavity having an interior surface 11 preferably with a groove 12 and a bottom surface. The predetermined of shape of the cavity is circular. A gear 13 is attached at the approximate center of the bottom surface 11. The first housing 10 has an attachment means at opposing ends of the first housing. Preferably, a conventional hook 18 and pin 17 connector attaches the first housing 10 to a linked watch band. Another embodiment (not shown) uses a strap attached to opposing edges of the first housing to snug the first housing to a solid type watchband.

FIG. 7 shows the second housing 20 having a first shell 31 and a second shell 32. The first shell 31 and second shell 32 are joined by a connecting means such as tongue and groove type mating means with an optional gasket 33 so that the second housing is watertight. Another embodiment not shown is a conventional screw and receiving thread arrangement (not shown). The first and second shells when assembled form a second cavity.

FIG. 8 is a cross section of the first housing. FIG. 9 shows working parts within the second housing including a power source, preferably a battery 26 in a battery compartment 25. The battery is one of nickel-cadmium, lithium ion and alkaline. A solar cell can also provide power. The power source is operably connected to a control unit with an integrated circuit 27. The control unit is operably connected to a display 23 unit that is preferably one of light emitting diode or liquid crystal display. At least a portion of the top surface of the second housing is transparent. An input means is disposed on an outer surface of the second housing 20. Preferably the input means is at least two switches 24 that are operably connected to the control unit 27. The switches allow the user to enter the correct day, date, time or other information for display. The control unit 27 has a clock to change the date and date with the passage of time. Optionally, the control unit 27 also has a memory unit operably connected so that the day, date and time or other information are preserved in the event the power source 26 fails or when the power source 26 is replaced by user.

FIG. 10 shows the exterior bottom surface of the second housing 20. There is an aperture in the bottom surface of the second housing unit. The aperture is located under the battery compartment 25 and has a panel 41 removably attached to the bottom of the second housing 20. The panel provides convenient access to the battery 26 so that the battery 26 can be replaced by a user. It is also contemplated that such panel may be held in place by a screw which can be unscrewed for removal of such panel to allow replacement of such battery. According to one embodiment, such battery may also be accessible via use of a jeweler's tool to separate the two housings by inserting the jeweler's tool between the mating portions of the two housings. The exterior bottom surface of the bottom second housing 20 has a flexible member 42 that is preferably manufactured from metal or plastic.

When assembled, the exterior surface of the second housing 21 has a rim 22 that is mating with groove 12. A gasket 28 is provided to form a watertight seal when assembled. The second housing 20 is received by the first cavity interior to the first housing 10. Flexible member 42 engages and cooperates with gear 13 so that the second housing 20 may rotate, but is limited to discrete stops and held in position by the flexible member 42 and gear 13. The user may overcome resistance of the flexible member 42 against gear 13 and rotate the second housing to another desired position. This allows the user to conveniently position the second housing independent of whatever position such watchband is aligned.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A display for a watchband comprising:
a housing member having a first shell and a second shell member, each of said shell members having a predetermined size and shape, said first and second shell members having a joining means, when assembled said first and second shell members form a cavity;
at least a portion of a top surface of said second shell of said housing member is transparent;
a predetermined power source located at a predetermined location within said cavity;
a control unit located at a predetermined location within said cavity operable connected to said power source; having an integrated circuit with a clock function to output day, date and other information;
a display means located at a predetermined location within said cavity operably connected to said power source and said control unit;
an input means on said housing member operably connected to said control unit; and
a band attaching means disposed on an outer portion of said housing member to attach said housing member to such watch band.

2. A display for a watchband according to claim 1 wherein said display means is one of an array of light emitting diodes and a liquid crystal display.

3. A display for a watchband according to claim 1 wherein said predetermined power source is one of an alkaline, lithium ion, nickel-cadmium and photo-voltaic.

4. A display for a watchband according to claim 1 wherein said housing member has at least 2 apertures and said input means is at least two switches received in an aperture in said housing and wherein said switches are each operably connected to said control unit.

5. A display for a watchband according to claim 1 further having a memory unit operably connected to said control unit to retain the date and day for a predetermined interval without a power source.

6. A display for a watchband according to claim 1 having an aperture in said housing member at a predetermined location generally adjacent to said power source and a panel removably attached engaging said housing member to allow a user to replace said power source.

7. A display for a watchband according to claim 1 wherein said display is integrally formed with at least one of a watchband, a clasp of a watchband, and a combination thereof.

8. A display for a watchband comprising:
a first housing having a predetermined shape and size, said housing having an upper portion with a lip, an inwardly facing surface and outwardly facing surface, the inwardly facing surface is a first cavity, said first cavity having a generally flat bottom surface;
a gear attached to the approximate center of said first housing bottom surface;
a first retaining means on said upper portion of said first housing;
a second housing having a first shell and a second shell member, each shell having a predetermined size and shape, said first and second shells having a joining means, when assembled said first and second shell members form a second cavity;
at least a portion of the top surface of said second shell of said second housing is transparent;
a predetermined power source located at a predetermined location within said second cavity;
a control unit located at a predetermined location within said second cavity operable connected to said power source; having an integrated circuit with a clock function to output day, date and other information;
a display means located at a predetermined location within said second cavity operably connected to said power source and said control unit;
an input means on said second housing operably connected to said control unit;
a flexible member attached at a predetermined location to said first shell of said second housing;
a second retaining means on said second housing means, wherein said first and said second retaining means engageably mate;
said second housing is received by said first cavity in said first housing and said first and said second retaining means mate to join said first housing and said second housing, said flexible member engages said gear such that said second housing rotates and is limited to discrete stops; and
a band attaching means at a predetermined location on an outer portion on said first housing to attach said first housing to such watch band.

9. A display for a watchband according to claim 8 wherein said display means is one of an array of light emitting diodes and a liquid crystal display.

10. A display for a watchband according to claim 8 wherein said predetermined power source is one of an alkaline, lithium ion, nickel-cadmium and photo-voltaic.

11. A display for a watchband according to claim 8 wherein said second housing has at least 2 apertures and said input means is at least two switches are received in an aperture in said housing; said switches are each operably connected to said control unit;

12. A display for a watchband according to claim 8 further having a memory unit operably connected to said control unit to retain the date and date for a predetermined interval without a power source.

13. A display for a watchband according to claim 8 having an aperture in said first shell of said second housing at a predetermined location generally adjacent to said power source and a panel removably attached engaging said second to allow the user to replace said power source.

14. A display for a watchband according to claim 8 wherein said predetermined shape of said first housing and said second housing is circular.

15. A display for a watchband according to claim 8 wherein said joining means of said first and said second shell is a tongue and groove joining means having a first portion disposed on said first shell and a second portion disposed on said second shell said first portion being engageable with said second portion and wherein said display further includes a gasket disposed between said first portion and said second portion.

16. A display for a watchband according to claim 8 wherein said first retaining means on said first housing is a groove and said second retaining means is a mating groove with a gasket between said first and second housings.

17. A display for a watchband according to claim 8 wherein said flexible member is manufactured of plastic or metal.

18. A display for a watchband according to claim 8 wherein said attachment means to such watchband is a link having a pin member and groove member at the opposing edges of the first housing along the longitudinal axis of such watch band, said pin and groove are received by corresponding tongue and groove at adjacent links in such watch band.

19. A display for a watchband according to claim 8 wherein said attachment means is:
a first strap member of a predetermined flexible material attached to a side of the housing transverse to the longitudinal axis of such watch band, and
an adjuster member through which said strap is threaded; a second strap attached to opposing side of said housing.

20. A display for a watchband comprising:
a first housing having a predetermined shape and size, said housing having an upper portion with a lip, an inwardly facing surface and outwardly facing surface, the inwardly facing surface is a first cavity, said first cavity having a generally flat bottom surface;
a gear attached to the approximate center of said first housing bottom surface;
a first retaining means on said upper portion of said first housing;
a second housing having a first shell and a second shell member, each shell having a predetermined size and shape, said first and second shells having respective mating portions, when assembled said first and second shell members form a second cavity;
at least a portion of said second shell of said second housing is transparent.
a battery in a battery compartment at a predetermined location within said second cavity, said battery being one of nickel-cadmium, lithium ion and alkaline;
an aperture in said first housing of said second housing at a predetermine location with a removable panel to provide access to said battery, so that said battery can be replaced;
a control unit located at a predetermined location within said second cavity operably connected to said power source, having an integrated circuit with a clock function to output day, date and other information, a memory unit to retain said day, date and other information without a battery ;
a display means located at a predetermined location within said second cavity operably connected to said power source and said control unit;
at least two switches on said second housing operably connected to said control unit for entry of said day, date, or other information;
a flexible member attached at a predetermined location to said first shell of said second housing;
a second retaining means on said second housing member, wherein said first and said second retaining means engageably mate;
said second housing is received by said first cavity in said first housing and said first and said second retaining means mate to join said first and said second housings, said flexible member engages said gear so that said second housing rotates and is limited to discrete stops; and
a band attaching means at a predetermined location on an outer portion said first housing to attach said first housing to such watch band.
